(19) United States
(12) Patent Application Publication
(10) Pub. No.: US 2011/0204704 A1
(43) Pub. Date: Aug. 25, 2011

(54) METHOD OF MAKING A WHEEL BALANCE ASSEMBLY

(76) Inventors: John William Charles Halle, Shrewsbury (GB); Richard Adam Watkin, Powys (GB)

(21) Appl. No.: 13/001,154

(22) PCT Filed: Apr. 30, 2009
(86) PCT No.: PCT/GB2009/001092

§ 371 Date: Dec. 23, 2010

(30) Foreign Application Priority Data
May 2, 2008 (GB) 0808079.8
Jul. 28, 2008 (GB) 0813768.9

(51) Int. Cl. F16F 15/32; B23K 31/02; B23K 31/12; B23P 17/04

(52) U.S. Cl. 301/5.21; 228/176; 228/103; 29/527.1

(57) ABSTRACT

A method of manufacturing a wheel balance assembly (500) from a clip and weight, the method comprising the following steps: 1. annealing at least a portion of the clip; 2. positioning the clip and weight adjacent one another; and 3. welding the clip and weight to one another.

### FIELD OF THE INVENTION

The present invention relates to a method of fabricating a wheel balance assembly and in particular, but not exclusively, the present invention relates to making a steel wheel balance assembly.

### BACKGROUND OF THE INVENTION

Where a tyre fitted to a wheel (or indeed the wheel itself) is heavier at one side that the other, an out-of-balance vibration can manifest itself during driving which can cause noticeable vibration on the steering wheel, and through the car itself. This causes tyres and mechanical parts to wear more quickly and ultimately could render a vehicle unsafe. Wheel balance assemblies are used to correct out-of-balance defects on tyred wheels, and are arranged to attach to the rims of wheel used by vehicles such as cars, buses, trucks or the like.

Where a tyre is observed to be out-of-balance, a wheel balance assembly of compensatory measure may be attached to the rim of the wheel diametrically opposite the heavier portion of the tyre/wheel.

For some types of wheel, such wheel balance assemblies are provided by a balance weight and a clip, wherein the balance weight is consolidated (for example by casting) around the clip to provide the complete assembly. Wheel balance assemblies of varying weights can therefore be provided by varying the amount of balance weight used.

Various means of attaching the weight to the clip in order to produce the wheel balance assembly are used and these are generally mechanical means such as riveting, peening. Such mechanical solutions do not attach the weight and clip as well as may be desired (both in terms of accuracy of alignment of the two components and in terms of the strength of the attachment) and also add significantly to the manufacturing process both in terms of cost and complexity. It is desirable to make hundreds of thousands or millions of assemblies a year as such it desirable to simplify the manufacturing process.

The use of adhesives has been proposed to adhere the clip and the mass, but adhesives tend to be expensive. Furthermore, curing times can lead to a slowing of the production process which can cause problems for a mass production process.

### SUMMARY OF THE INVENTION

According to a first aspect of the invention there is provided a method of manufacturing a wheel balance assembly from a clip and weight, the method comprising the following steps:

1. annealing at least a portion of the clip;

2. positioning the clip and weight adjacent one another; and

3. welding the clip and weight to one another.

Generally, the method is performed in the order shown, although the steps 1 to 3 may be performed in a different order. For example, the order of steps 1 and 2 may be switched.

Such a method is believed to provide a superior wheel balance assembly when compared to the prior art. The welding process can be made highly repeatable such that the mass and the clip tend to aligned as desired in relation to one another which tends to lead to a more aesthetically pleasing assembly. Furthermore, the bond between the clip and the weight tends to be of superior strength when compared to prior art mechanical fixings.

The clip tends to be manufactured from spring steel in order that it shows the necessary resilience to hold the assembly in place on a wheel. The skilled person will appreciate that spring steel, is by its nature, hardened and as such it is a difficult material to which to weld. Should it be attempted to simply weld the clip and the weight, then the assembly is likely to be of poor quality since the spring steel of the clip is made brittle by the welding process. Therefore, there is a prejudice in the art toward using welding to adhere the clip and the weight. However, it has been found that annealing at least a portion of the clip can ameliorate this problem and allow a spring steel clip to be adhered to a weight.

The method may comprise feeding the clips from a hopper, which may be of the vibrating bowl feeder variety. Such a feeder is advantageous due to the feed rates that are generally achievable. In some embodiments, a feed rate of in the region of 40 parts per minute is achieved. However, other embodiments, may achieve in the region of roughly 20 to 60 parts per minute.

Following the hopper a track and rail system having over balance rejection may be used to ensure that clips are of the correct orientation.

Further, the method may comprise feeding the weights from a hopper, which may be of the vibrating bowl feeder variety.

The method may comprise using weights which have a back face and a front face and which the front face is visually distinguishable from the back face. At least one of the front and the back faces typically has a marking thereon and generally, the front face has a marking thereon. Not only does a marking allow a trade mark or other logo to be applied to the weight but it may allow a rejection system to determine whether the weight is correctly orientated.

In some embodiments, the feeder is followed by a rejection system which helps to ensure that weights being passed from the hopper are correctly orientated. In some embodiments, the rejection system is provided by a camera based rejection system. Typically, the camera based rejection system is arranged to determine whether a logo is visible on a viewable face and to reject the weight if this determination does not provided the desired answer. Rejected weights are typically returned to the hopper.

Generally, the clip comprises an attachment portion and a spring portion, wherein the spring portion is arranged to attach the assembly to a wheel and the attachment portion is arranged to have the weight attached thereto.

Some embodiments of the method use a clip having one or more projections on the attachment portion. Such projections allow so-called projection welding to be utlised which can increase the quality of the weld between the clip and the weight.

In some embodiments, the method comprises annealing the attachment portion but substantially not annealing the spring portion. Such an arrangement is convenient as it leaves the properties of the spring portion substantially unchanged such that it is still suitable for holding the assembly in place on a wheel.

The annealing process may occur after the clip has been taken from the hopper and ensured that it is in the correct orientation.

The annealing process may be performed by an induction heater. Such a method is convenient as it can be utilised within a high volume process and is suitable for providing localised heating of the clip.

Typically, the annealing process heats the clip to in the range of roughly 500° C. to 1100° C. Some embodiments may heat the clip to in the range of roughly 650° C. to 950° C. One particular embodiment heats the clip to roughly 800° C.

The method may drive the clip through the induction heater as opposed, for example, to using gravity feed, or the like. Driving the clip in this manner can help to ensure that the clip is within the induction heater for a predetermined amount of time.

In one embodiment, the clip is arranged to spend roughly 1 second within the induction heater. However, in other embodiments, the clip may spend in the region of 0.25 seconds to 4 seconds within the induction heater. In further embodiments, the clip may spend roughly 0.5 seconds to 2 seconds or 3 seconds within the induction heater.

The clip may loaded into a tool, and this typically occurs after the clip has been annealed.

Advantageously, the method uses a copper tool to hold the weight. It has been found that use of a copper tool can improve the welding process when compared to use of a steel tool. For example, it is likely that a copper tool can be loaded more quickly than a steel tool since a copper tool can be shallower as it itself provides an electrode for the welding process rather than copper electrodes within a steel tool. Moreover, since a copper tool would provide a larger surface area contact when compared to electrodes within a steel tool, weld scarring on the wheel balance assembly is typically reduced and also the tool may last longer.

The clip may be loaded into a tool adjacent the weight.

The method may arrange the clip such that the projections on the attachment portion are adjacent the weight when the two parts are brought together. Such a method is convenient as the projections provide a current path between the two parts which helps to ensure a good quality weld.

In some embodiments, the weight and the clip are clamped against one another. Such clamping is advantageous as it helps to prevent movement during the welding process and also helps to ensure that there is a good current path between the clip and the weight which helps to ensure a good quality weld.

Typically, the clamping pressure is on the order of 1000 kg. However, in other embodiments the clamping pressure may be in the region of roughly 750 kg to 1500kg. In yet further embodiments, the clamping pressure may be in the region of roughly 850 kg to 1250 kg or any pressure in between. Such clamping pressures are sufficient to hold the clip and the weight adjacent one another but are not high enough to damage the clip or weight or flatten the projections.

In some embodiments the method monitors parameters of the weld. Such parameters may include any of the following: weld cycle time, clamp pressure, current, voltage.

The method may be arranged to reject assemblies if any of the parameters are outside of a predetermined tolerance.

The skilled person will appreciate that during a welding process such as that described herein, which is similar to a spot welding process, material is deposited on the electrodes as the process repeats (so-called ‘pick-up’). Such deposited material tends to increase the resistance of the current path which can lead to the quality of the weld not being as good as desired. As such the method may apply so-called up stepping in which the current is increased as the resistance of the current path increases.

An initial step of the method may test the material of one or other or both of the weight and clip. The method may then set the parameters of the remainder of the process according to the results of the material testing.

Once the assembly has been formed by welding the clip and the weight, it may be heat treated to re-harden the clip to, or at least close to, its hardness before it was annealed.

In a further step of the process, the assembled wheel balance assembly may have a surface finishing process applied thereto. The surface finish may be applied to the whole assembly or may be applied to portions thereof. In one particular embodiment, the surface finishing process is applied to at least a rear face (i.e. the face on which the clip is attached to the weight) of the assembly.

In another embodiment, the surface finishing process may be applied to a rear face of the clip of the assembly. Such a method may allow the method to be applied to a variety of weight masses, since the dimension of the clip may remain constant irrespective of the mass of the weight which is welded thereto.

Conveniently, the surface finish comprises spraying the assembly, such as with a wet spray and/or with an inkjet. However, any other suitable surface finish may be used. For example, powder coating, generally with a plastics material, may be used. In other embodiments, the surface finishing process may comprise adhering a label to the assembly, or a portion of the assembly. Embodiments, which apply a surface finish have a number of potential advantages: the welding process can leave weld burn visible which the surface finish can cover which provides a more aesthetically pleasing assembly; and the surface finish may provide a further corrosion resistant finish improving the life of the product.

In some embodiments, the surface finish provides information about the assembly to which the finish is applied. In some embodiments, the colour of the surface finish may provide the information. In other alternative, or additional, embodiments, the surface finish may comprise adding characters or other discernible indicia. Discernible indicia includes bar codes, logos, trade marks, or the like. Thus, the surface finish may provide a user with information about the assembly such as the mass of the assembly, the type of vehicle for which the assembly may be fitted, the profiled of the wheel rim to which the assembly may be fitted, etc. As such, it may be easier for a user to fit the assemblies and may reduce the number of assemblies which are wasted through mis-fitting.

The characters or other indicia may be added as the surface finish to the assembly. Alternatively, or additionally, the character or indicia may be added after a previous surface finish such that the character or indicia is viewable.

The surface finish may be applied in a plurality of coats. In one embodiment, a primer is applied to the assembly before a further layer is applied. In some embodiments, indicia or other discernible indicia may be applied on top of another coat.

It is known that commercial inkjet spray heads comprise a plurality of nozzles. Embodiments of the present invention may be arranged to utilise a different nozzle to apply a different coat of surface finish. For example, a first nozzle may be used to apply an undercoat and a further nozzle may be used to apply a further coat. Such a method may speed the process of surface finishing the assembly.

The character or indicia may comprise a company logo or trade mark.

According to a second aspect of the invention there is provided a wheel balance assembly comprising a clip to which a weight has been welded, wherein at least a portion of the clip has been softened when compared to spring portion of the clip arranged to grip the rim of a wheel rim.

The clip generally comprises an attachment portion and a spring portion wherein the attachment portion has the weight attached thereto and the spring portion is arranged in use to grip the rim of a wheel.

Some embodiments, of the invention have the attachment portion annealed whilst the spring portion remains substantially un-annealed. Generally, the spring portion is fabricated from so-called spring steel.

According to a third aspect of the invention there is provided a wheel balance assembly having at least a portion which is colour coded according to a predetermined code.

Such a wheel balance assembly may allow users to determine more easily one or more parameters of the assembly.

The assembly may comprise more than one coloured portion. Such an arrangement may allow more than one parameter of the weight to be indicated. For example, a first coloured portion may be used to indicate to which wheel rims the assembly may be attached and a second parameter may indicate the mass of the assembly.

The colour may comprise a paint, ink, or plastics material. Generally, the colour may applied in a surface processing step. However, in additional, or alternative embodiments, portions of the material from which the assembly is fabricated may be coloured.

According to a fourth aspect of the invention there is provided a method of fabricating a wheel balance assembly comprising attaching a weight to a clip and subsequently applying a surface finish to colour at least a portion of the assembly according to a predetermined code.

The surface finish may have any of the features of the surface finish discussed in relation to the first aspect of the invention. Indeed features of any one aspect of the invention may be used mutatis mutandis in relation to any other aspect of the invention.

### BRIEF DESCRIPTION OF THE DRAWINGS

There now follows by way of example only a detailed description of the present invention with reference to the accompanying drawings in which:

FIG. 1 shows a clip used to fabricate a wheel balance assembly;

FIG. 2 shows a weight which is attached to the clip of FIG. 1 in order to fabricate a wheel balance assembly;

FIG. 3 shows a flow chart outlining the steps in a method of making a wheel balance weight;

FIG. 4 shows an assembled wheel balance assembly; and

FIG. 5 shows a rear face of the assembly highlighting a portion to which a surface finish is applied.

### DETAILED DESCRIPTION OF THE DRAWINGS

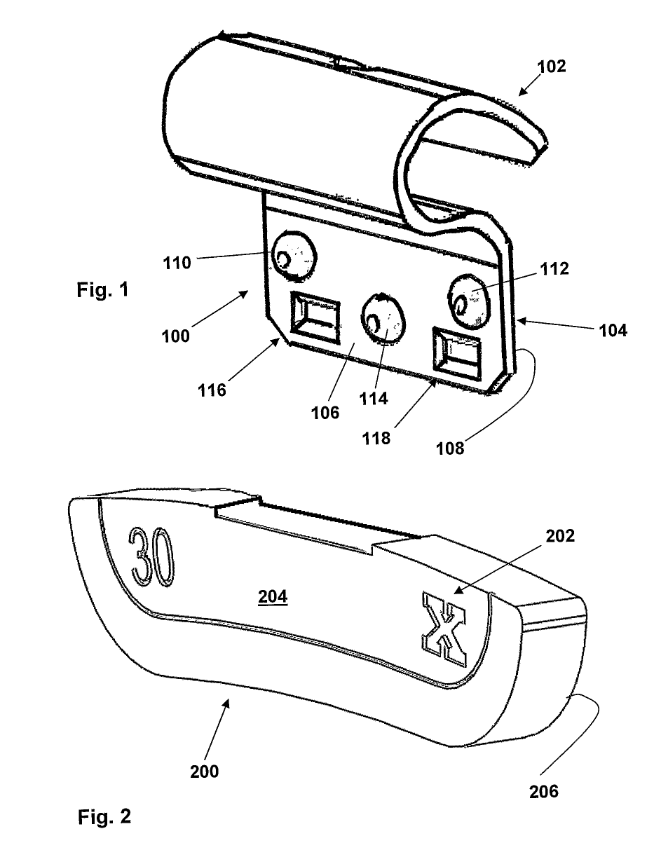

The clip 100 shown in FIG. 1 comprises a spring portion 102 and an attachment portion 104 to which a weight can be attached. The clip 100 is fabricated from spring steel.

The attachment portion 104 comprises an attachment face 106 to which a weight is attached and a wheel engaging face 108 which, in use, is adjacent a wheel to which the assembled wheel balance assembly is attached. Protruding from the attachment face 106 are a number of projections 110, 112, 114 and in the embodiment being described there are three such projections. However, in other embodiments, there may be any other number, such as 1, 2, 4, 5, 6, or more. The attachment portion 104 also has some wheel engaging projections 116, 118 pressed thereinto, which cause projections on the wheel engaging face 108 and depressions on the attachment face 106.

The weight 200 shown in FIG. 2, comprises in the embodiment being described, a substantially three dimensional rectangular shape. In the embodiment being described the weight is fabricated from steel. The weight may be of a variety of masses, and for example may be roughly any of the following masses: 5 g, 10 g, 15 g, 20 g, 25 g, 30 g, 50 g, 100 g, or any mass in between these.

The weight 200 comprises, in a top right corner as viewed in the Figure, a logo 202 which in this example is an ‘X’. The logo 202 is on a front face 204 of the weight which is opposite a back face 206 thereof.

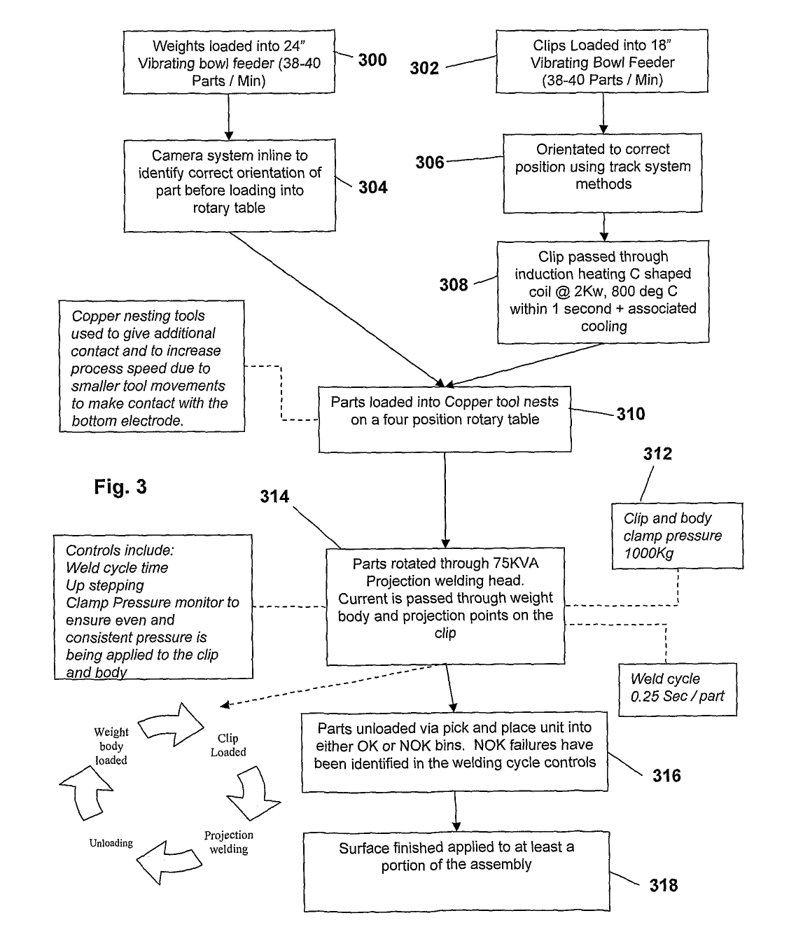

The clip 100 and the weight 200 are welded to one another as described in relation to the flow chart of FIG. 3.

Firstly, a vibrating bowl feeder is loaded with weights in step 300 and a second vibrating bowl feeder is loaded with clips in step 302.

The first bowl feeder causes weights 200 to be ejected from its ejection mechanism. In the embodiment being described, the ejection can happen in one of two orientations: with the front face 204 uppermost or the back face 206 uppermost. The curved nature of the weight stops there from being further orientations which could be confused with one another; i.e. it would be evident from the curved nature if the weight were upside down as shown in the figure.

Thus, in step 304 a camera and associated processing circuitry is used to determine whether the weight 200 has the correct orientation. The camera is arranged to determine whether the logo 202 is viewable or not and if the logo cannot be seen the weight 200 is rejected back in to the bowl feeder for re-circulation.

In step 306 the second bowl feeder causes clips to be ejected from an ejection mechanism thereof along a track system and the track is arranged to utilise an over balance rejection system to ensure that the clips are orientated in the desired orientation.

In step 308 the clips are gravity fed along the track until they reach an induction heater which is a substantially 2 kW induction heater of a ‘C’ shaped orientation. The clip is driven through the heater using a linear drive rail. Alternative embodiments, may use a pneumatic cylinder. The clip is arranged such that the attachment portion 104 is passed between the arms of the C of the induction heater. The drive of the clip is arranged such the attachment portion 104 remains with the induction heater for roughly 1 second and in this time a heating pulse drives the induction heater such that the attachment portion is heated to roughly 800° C.

Next, in step 310, the clips are loaded into a tool nest which is fabricated from copper. Once the clip has been loaded a weight is loaded into the nest a weight 100 is loaded such that the back face 206 is adjacent the attachment face 106 of the clip 100. The tool nest is part of a rotary table, which comprises, in this embodiment, four positions to receive a clip.

Once both parts are in position within the tool nest a top electrode is brought into contact with the weight 200 and a clamping pressure 312 of roughly 1000 kg is applied between the top electrode and tool next to clamp the clip 100 and the weight 200 adjacent one another.

Once the clip 100 and the weight 200 are clamped in position a welding pulse is applied 314 to create a projection weld between the attachment face 106 and the weight 200. That is the three projections 110, 112, 114 are welded into the weight. During the weld, various weld parameters, including clamp pressure, current, duration and voltage are monitored by processing circuitry controlling the process.

The welding cycle takes roughly 0.25 s although in other embodiments, other weld times may be appropriate.

In one embodiment the welding is controlled by a Sy-sol weld controller.

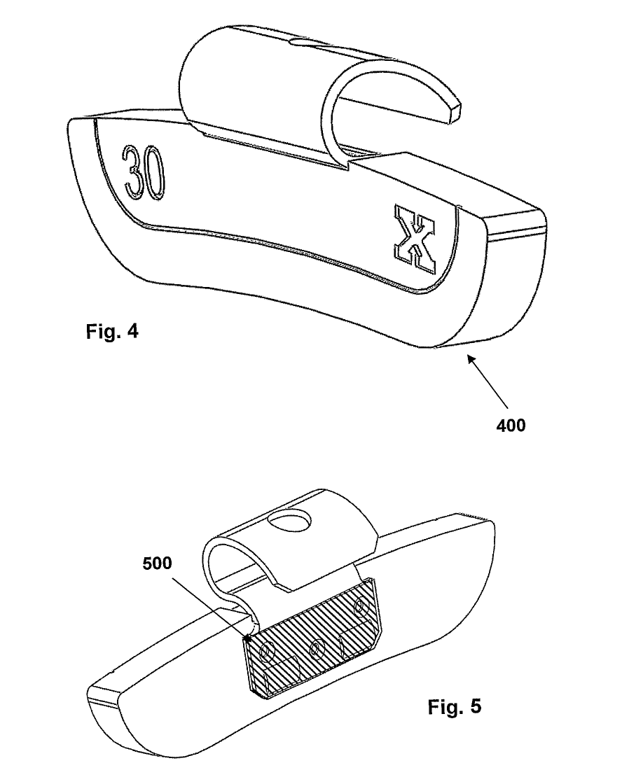

Once the weld is complete, the rotary table is rotated in order that the completed wheel balance assembly 400, as shown in FIG. 4, can be ejected 316. If the processing circuitry that has monitored the weld determines that the parameters of the weld fell within predetermined tolerances then the weld assembly is accepted and it is ejected into an OK bin. If the processing circuitry determines that the parameters of the weld fell outside these predetermined parameters then the assembly 400 is ejected into a NOK (Not OK) bin.

The completed assembly may be forwarded for further processing such as coating, painting or the like.

In a further step of the process a surface finish is applied to a back portion of the assembly which in the embodiment being described comprises a portion of the clip that overlaps the rear face of the weight (i.e. the face that will in use be adjacent the wheel). This portion is shown in FIG. 5 by the cross hatching 500.

The surface finish comprises colouring using an ink jet printing system according to a predetermined code. In this embodiment, the colour which is applied to the rear face of the clip is used to indicate the wheel rim profile to which the clip can be applied.

1. A method of manufacturing a wheel balance assembly from a clip and weight, the method comprising the following steps:
1. annealing at least a portion of the clip;
2. positioning the clip and weight adjacent one another; and
3. welding the clip and weight to one another.

2. The method of claim 1 in which the clip is manufactured from spring steel.

3. The method of claim 1 or 2 in which the weight is manufactured from steel.

4. The method of any preceding claim in which the clip comprises an attachment portion and a spring portion, wherein the spring portion is arranged to attach the assembly to a wheel and the attachment portion is arranged to have the weight attached thereto and the method comprises annealing the attachment portion but substantially not annealing the spring portion.

5. The method of any preceding claim which comprises using weights which have a back face and a front face and which the front face is visually distinguishable from the back face.

6. The method of claim 5 which utilises a rejection system to ensure that weights being passed from a hopper are correctly orientated and the rejection system is provided by a camera based system arranged to use the visual distinguishableness of the front and back faces.

7. The method of any preceding claim which uses clips having one or more projections on the attachment portion.

8. The method of claim 7 in which the projections are used to perform a projection weld.

9. The method of any preceding claim in which annealing of the clip is performed by an induction heater.

10. The method of claim 9 in which the clip is driven through the induction heater.

11. The method of any preceding claim in which a copper tool is used to hold the clip.

12. The method of any preceding claim in which the weight and the clip are clamped against one another.

13. The method of any preceding claim in which a welding pulse is applied to the clip and the weight, typically to the projections of the attachment portion.

14. The method of any preceding claim which monitors parameters of the weld, which includes any of the following: weld cycle time, clamp pressure, current, voltage.

15. The method of claim 14 which is arranged to reject assemblies if any of the parameters are outside of a predetermined tolerance.

16. The method of any preceding claim which tests the material of one or other or both of the weight and clip and subsequently sets the parameters of the remainder of the process according to the results of the material testing.

17. The method of any preceding claim in which the completed assembly is heat treated to re-harden the clip to, or at least close to, its hardness before it was annealed.

18. A wheel balance assembly comprising a clip to which a weight has been welded, wherein at least a portion of the clip has been annealed.

19. A wheel balance assembly according to claim 18 which comprises an attachment portion and a spring portion wherein the attachment portion has the weight attached thereto and the spring portion is arranged in use to grip the rim of a wheel.

20. A wheel balance assembly according to claim 19 in which the attachment portion is annealed whilst the spring portion remains substantially un-annealed.

21. A method of fabricating a wheel balance assembly comprising attaching a weight to a clip and subsequently applying a surface finish to colour at least a portion of the assembly according to a predetermined code.

22. A wheel balance assembly having at least a portion which is colour coded according to a predetermined code.
